(19) United States
(12) Patent Application Publication
(10) Pub. No.: US 2025/0099961 A1
(43) Pub. Date: Mar. 27, 2025

(54) LOW VOLUME ALIQUOT TUBE

(71) Applicant: Laboratory Corporation of America Holdings, Burlington, NC (US)

(72) Inventors: David Wilson, Burlington, NC (US); Kevin Meyer, Burlington, NC (US); Steven Cohen, Burlington, NC (US); Leah Priest, Burlington, NC (US)

(21) Appl. No.: 18/894,672

(22) Filed: Sep. 24, 2024

Related U.S. Application Data
(60) Provisional application No. 63/585,140, filed on Sep. 25, 2023.

(51) Int. Cl. B01L 3/00

(52) U.S. Cl. CPC B01L 3/5082; B01L 2300/0832; B01L 2300/0851

(57) ABSTRACT

A sampling tube for sampling processes, such as but not limited to automated sampling processes, includes a sample cavity with a changing diameter section proximate to a bottom end of the sampling tube to minimize dead sample volume. In some cases, the changing diameter section of the sample cavity has a plurality of sub-sections including at least one sub-section with a decreasing diameter and at least one sub-section with a constant diameter. An outer surface of the sampling tube may include one or more recessed portions defined in the outer surface proximate to the bottom end of the sampling tube.

### REFERENCE TO RELATED APPLICATION

This application claims the benefit of U.S. Provisional Patent Application No. 63/585,140, filed on Sep. 25, 2023, and entitled LOW VOLUME ALIQUOT TUBE, the content of which is hereby incorporated by reference in its entirety.

### FIELD OF THE INVENTION

This invention relates to medical devices, and more particularly to sampling tubes such as but not limited to low volume sampling tubes.

### BACKGROUND

Blood samples and other biological fluid specimens are routinely taken and analyzed in hospital and clinical situations for various medical purposes. Collection, handling and testing of these samples typically requires the use of various medical testing instruments. As the blood and fluid specimens are usually collected in a standard sized collection tube, the medical instruments used to test the samples are designed to accommodate these standard sized collection tubes.

Conventional blood collection tubes used in most clinical situations are elongated tubes having one end closed by a hemispherical or rounded portion and an opposed open end. The open end may be sealed by a resilient cap or stopper. The tube defines a sample cavity which collects and holds the blood sample. However, the rounded bottom ends make it difficult to remove the entirety of the sample within the sample cavity during automated sampling, and there is often a significant residual sample, or dead volume, left at the bottom end of the tube. Such a significant residual sample in traditional tubes may be particularly problematic for low volume samples (e.g., pediatric, geriatric, and/or hospital samples) where the total sample volume may be 1 mL or less, and the sample level retrieved may be inadequate for analysis and/or result in erroneous analytical results, potentially affecting the diagnosis and treatment given to the patient. %

Tubes with conical bottom ends have been proposed to reduce the dead volume. However, such tubes are not compatible with standard equipment of automated sampling systems, and the conical bottom end prevents the tubes from sitting securely on standard equipment and/or makes the tube susceptible to movement during retrieval of the sample.

Tubes with a “false bottom” have been proposed, but these tubes are not compatible with standard equipment of automated sampling systems due to their design of a false bottom with a generally flat or planar bottom end.

Add-on devices or structures have been proposed in view of the limitations of the aforementioned tubes. For example, conical inserts have been proposed for traditional tubes with rounded bottom ends and sleeves have been proposed for the tubes with conical bottom ends or false bottom ends. However, such add-on devices or structures are separate from the tube and must be manually inserted or assembled with the tube, thereby making them unsuitable for automated sampling systems or otherwise requiring time-consuming manual intervention and disruption of the automated process.

As such, there is still a need for a sampling tubes that are compatible with standard equipment and/or instrumentation while improving retrieval of the sample and minimizing dead volume during automated sampling.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 is a perspective view of a sampling tube according to embodiments.

FIG. 2 is another perspective view of the sampling tube of FIG. 1.

FIG. 3 is a side view of the sampling tube of FIG. 1.

FIG. 4 is another side view of the sampling tube of FIG. 1.

FIG. 5 is a top view of the sampling tube of FIG. 1.

FIG. 6 is a bottom view of the sampling tube of FIG. 1.

FIG. 7 is a sectional view of the sampling tube of FIG. 1 taken along line A-A in FIG. 4.

FIG. 8 is a sectional view of the sampling tube of FIG. 1 taken along line B-B in FIG. 5.

FIG. 9 is a perspective view of a sampling tube according to embodiments.

FIG. 10 is another perspective view of the sampling tube of FIG. 9.

FIG. 11 is a side view of the sampling tube of FIG. 9.

FIG. 12 is another side view of the sampling tube of FIG. 9.

FIG. 13 is a top view of the sampling tube of FIG. 9.

FIG. 14 is a bottom view of the sampling tube of FIG. 9.

FIG. 15 is a sectional view of the sampling tube of FIG. 9 taken along line A-A in FIG. 12.

FIG. 16 is a sectional view of the sampling tube of FIG. 9 taken along line B-B in FIG. 13.

### DETAILED DESCRIPTION

Described herein are improved sampling tubes for automated sampling systems, although they are not limited to automated sampling systems. In certain embodiments, the sampling tubes described herein have a sample cavity that minimizes dead volume during retrieval of the sample while also having an outer profile similar to a standard sampling tube with rounded bottom end, thereby allowing the sampling tubes to be used in standard equipment of the automated sampling system (e.g., they can be inserted and securely positioned in conventional cartridge racks). The sampling tubes described herein may have a sample cavity with a conical section and/or changing diameter section at the bottom end of the tube in order to reduce sample dead volume. In some embodiments, the conical section may include a plurality of sub-sections, which may allow for efficient funneling of low volume samples to the bottom of the sample cavity. In some embodiments, the plurality of sub-sections may further provide a smaller diameter and a smaller dead volume compared to a single conical section. While the sampling tubes described herein may be useful for various tube sizes and/or sample volumes, they may be particularly useful for samples that are less than or equal to about 1 mL. In some embodiments, the sampling tubes described herein may reduce a dead volume of a sample from about 0.5 mL to less than about 0.1 mL. Various other benefits and advantages may be realized with the systems, devices, and methods provided herein, and the aforementioned advantages should not be considered limiting.

FIGS. 1-8 illustrate an example of a sampling tube 10 according to embodiments. The sampling tube 10 may be constructed from various materials as desired. In one non-limiting example, the sampling tube 10 may be constructed from a plastic material, such as but not limited to polypropylene, polycarbonate, polyethylene terephthalate, polyethylene, polyethylene naphthalate, polyvinyl chloride, combinations thereof, and/or other materials as desired. The sampling tube 10 may be formed via various techniques as desired, such as but not limited to, injection molding, vacuum forming, pressure forming, extrusion, casting, combinations thereof, and/or other suitable techniques as desired. %

The sampling tube 10 generally includes a top end 12 and a bottom end 14 opposite from the top end 12. The sampling tube 10 further includes an outer surface 16, which extends from the top end 12 to the bottom end 14, and an inner surface 18, which defines a sample cavity 20 for receiving a sample or specimen, such as but not limited to a biological fluid sample.

The top end 12 of the sampling tube 10 defines an opening 22 to the sample cavity 20. The opening 22 may be selectively closed or sealed (e.g., with a cap, stopper, plug, or other suitable device or mechanism) when the sampling tube 10 is not in use and/or the sample is not being supplied into and/or retrieved from the sample cavity 20. Optionally, a flange 24 is provided at the top end 12 and may be utilized to facilitate engagement with the cap, stopper, plug, or other device used to close the opening 22 and/or to facilitate orientation for automated handling processes; however, in other embodiments, the sampling tube 10 need not include the flange 24.

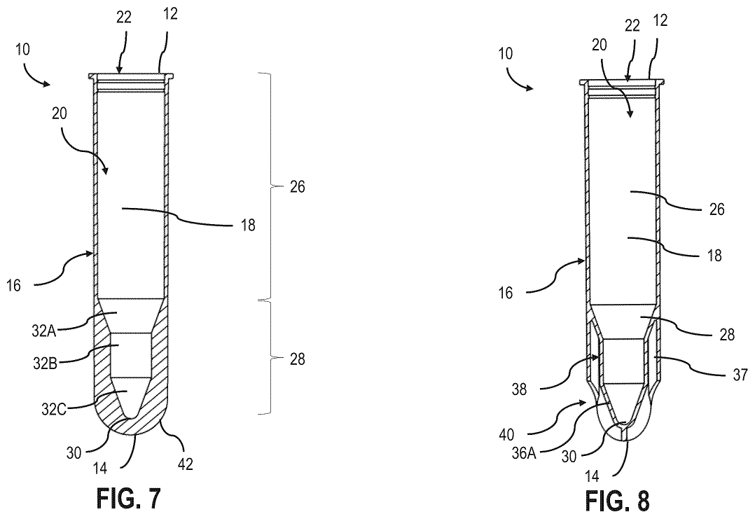

The sample cavity 20 may have various volumes as desired. In a non-limiting example, the volume of the sample cavity 20 may be 8.2 mL, although it need not be in other embodiments. As best illustrated in FIGS. 7 and 8, the sample cavity 20 includes a tubular (or cylindrical) section 26 and a changing diameter section 28, and the changing diameter section 28 is provided proximate to the bottom end 14 of the sampling tube 10. In some embodiments, the changing diameter section 28 may be a conical section and/or have any other profile as desired. The changing diameter section 28 of the sample cavity 20 may facilitate access to smaller samples within the sample cavity 20 as less of the sample remains in a tip or bottom end 30 of the sample cavity 20 compared to a rounded bottom end. In some embodiments, the volume of the changing diameter section 28 may be different from the volume of the tubular section 26. As a non-limiting example, the volume of the changing diameter section 28 may be 1.4 mL, and the volume of the tubular section 26 may be 6.8 mL, although in other embodiments the sections 26, 28 may have other volumes as desired.

In some embodiments, and as best illustrated in FIGS. 7 and 8, the changing diameter section 28 includes a plurality of sub-sections 32. In these embodiments, the changing diameter section 28 with the sub-sections 32 may facilitate funneling of the sample within the sample cavity 20. The sub-sections 32 may further allow for the sub-section defining the bottom end 30 of the sample cavity 20 (e.g., sub-section 32C) to have a smaller diameter, and therefore smaller dead volume, compared to a conical section having a full diameter. In one non-limiting example, the sampling tube 10 with the changing diameter section 28 may reduce a dead volume of a sample from about 0.5 mL to less than about 0.1 mL. In other words, the sampling tube 10 with the changing diameter section 28 improves the retrieval of the sample from the sample cavity 20 during sampling such as but not limited to automated sampling.

In various embodiments, the plurality of sub-sections 32A-C includes at least one sub-section with a constant diameter (e.g., sub-section 32B) and at least one sub-section with a decreasing diameter (e.g., sub-section 32A or sub-section 32C). In the embodiment illustrated, the changing diameter section 28 includes three sub-sections-a first sub-section 32A with a decreasing diameter, a second sub-section 32B with a constant diameter, and a third sub-section 32C with a decreasing diameter. In this example, the first sub-section 32A is adjacent to the tubular section 26, and a maximum diameter of the tubular section 26 may be the same as the diameter of the tubular section 26. A minimum diameter of the first sub-section 32A may be the same as the constant diameter of the second sub-section 32B. A maximum diameter of the third sub-section 32C may be the same as the constant diameter of the second sub-section 32B. As mentioned, the third sub-section 32C may include the bottom end 30 of the sample cavity 20. While three sub-sections 32A-C are illustrated, any number may be included.

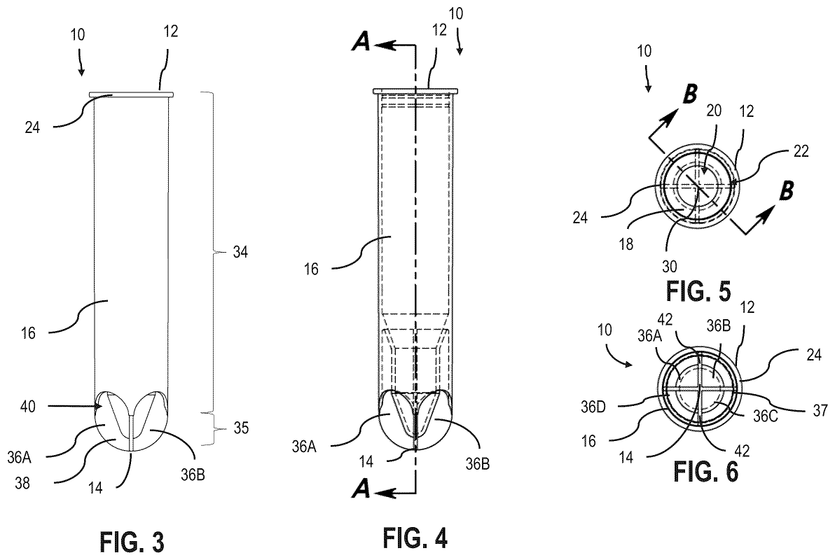

As illustrated in FIGS. 1 and 3, for example, the outer surface 16 of the sampling tube 10 may include a tubular portion 34 and a domed or rounded portion 35. The tubular portion 34 may include the top end 12, and the rounded portion 35 may include the bottom end 14.

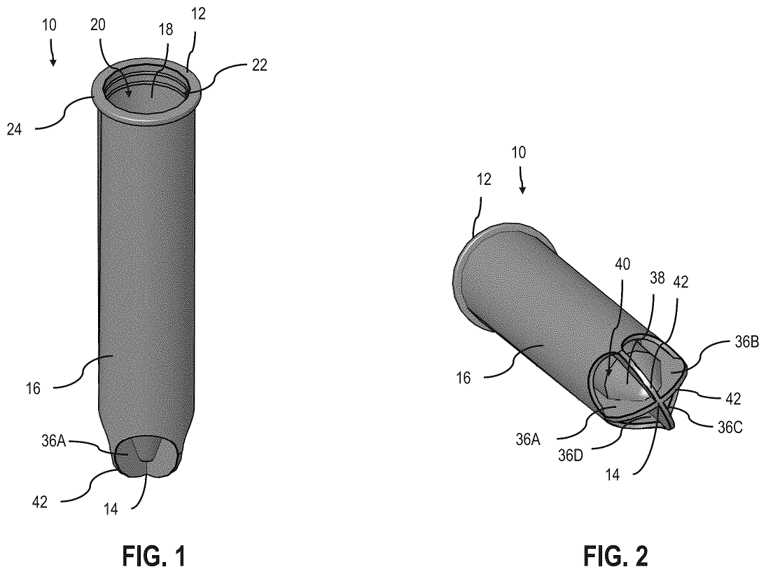

In certain embodiments, one or more recessed portions 36 are defined in the outer surface 16 proximate to the bottom end 14. The one or more recessed portions 36 may be defined at least partially within the rounded portion 35 of the outer surface 16. While four recessed portions 36A-D are illustrated, any number may be included. As other non-limiting examples, the outer surface 16 may include two recessed portions, three recessed portions, four recessed portions, five recessed portions, six recessed portions, etc. Each recessed portion 36 has a recessed portion surface 38 that is recessed relative to the outer surface 16. In certain embodiments, the recessed portions 36 may form rib sections 42 of the outer surface 16 between adjacent recessed portions 36, and the number of rib sections 42 of the outer surface 16 may depend on the number of recessed portions 36 defined in the outer surface 16. Optionally, and as best illustrated in FIGS. 2 and 8, a portion of the recessed portion surface 38 may be between the outer surface 16 and the inner surface 18, thereby defining a pocket 37; however, in other embodiments, it need not, and the pocket 37 may be omitted. In certain embodiments, a length of each recessed portion 36 is less than a length of the sample cavity 20. The openings 40 for each recessed portion 36 may have various shapes or profiles. As one non-limiting example, and as illustrated, the openings 40 may be scalloped openings.

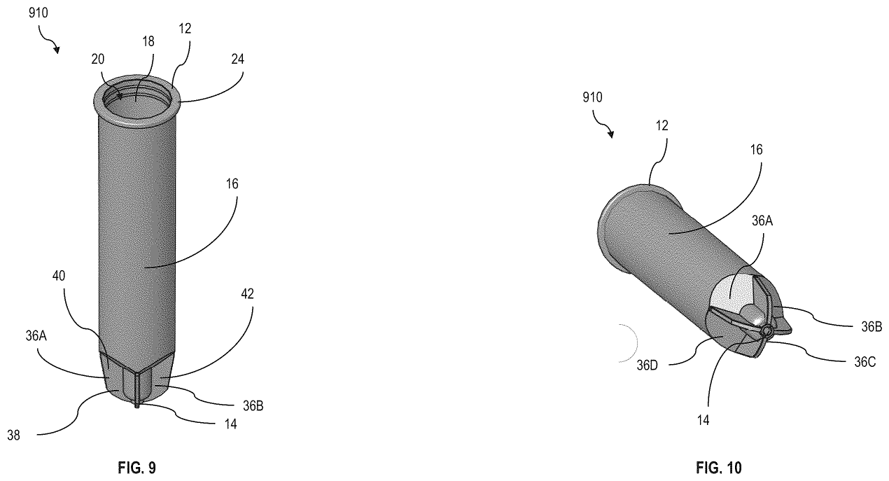

The sampling tube 10 with the one or more recessed portions 36 may facilitate manufacturing of the sampling tube 10 and reduce the amount of material used to construct a sampling tube 10. As an example, the one or more recessed portions 36 may eliminate a solid void volume from otherwise being formed between the inner surface 18 and the outer surface 16, particularly between the changing diameter section 28 of the sampling cavity 20 and the outer surface 16. The one or more recessed portions 36 may also allow for the sampling tube 10 to have an outer profile similar to a standard sampling tube, thereby allowing the sampling tube 10 to be used in standard equipment of automated sampling systems. In some embodiments, the plurality of recessed portions 36 may facilitate insertion of the sampling tube 10 into standard equipment used in automatic sampling systems. In other embodiments, and as illustrated in FIGS. 9-16, the sampling tube 10 need not include the optional recessed portions 36.

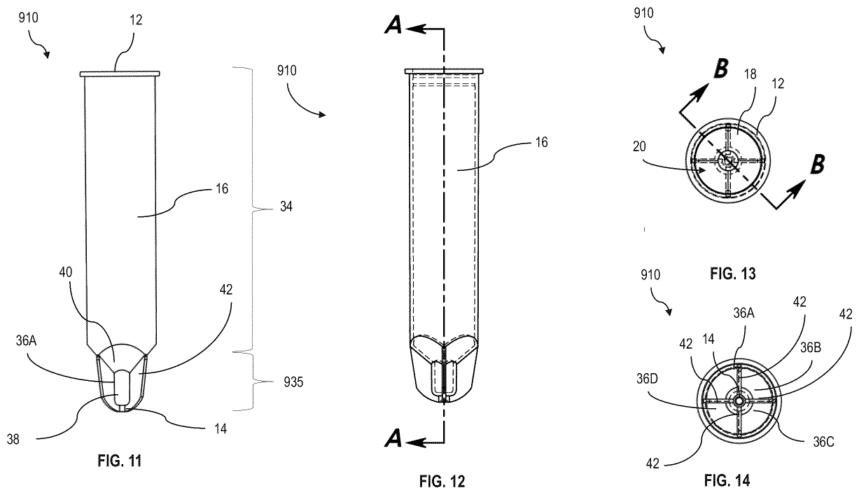

FIGS. 9-16 illustrate another example of a sampling tube 910 according to embodiments. The sampling tube 910 is similar to the sampling tube 910 except that the sampling tube 910 omits the pockets 37. In addition, and as illustrated in FIG. 11, for example, the outer surface 16 of the sampling tube 910 may include the tubular portion 34 and a domed or rounded portion 935. In this example, and compared to the sampling tube 10, the domed or rounded portion 935 is a pyramidal shape (e.g., with linear, angled sections). The tubular portion 34 may include the top end 12, and the rounded portion 35 may include the bottom end 14.

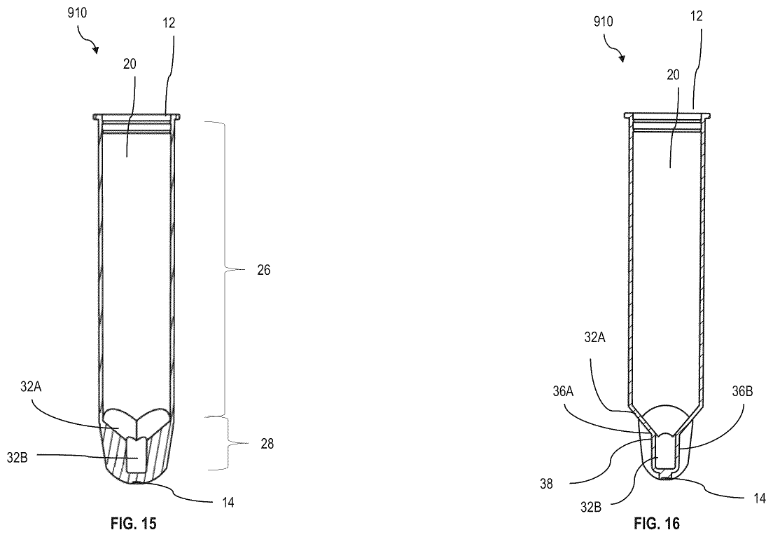

In various embodiments, and as illustrated in FIG. 15, the changing diameter section 28 includes two sub-sections 32. Similar to the sampling tube 10, the changing diameter section 28 with the sub-sections 32 may facilitate funneling of the sample within the sample cavity 20. Compared to the sampling tube 10, the sub-sections 32 of the sampling tube 910 include a first sub-section 32A that is conical (e.g., with a reducing diameter towards the bottom end 14) and a second sub-section 32B with a constant diameter less than the full diameter of the sample cavity 20.

A collection of exemplary embodiments is provided below, including at least some explicitly enumerated as an “Illustration” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.
Illustration 1. A sampling tube comprising: a top end; a bottom end; an outer surface extending from the top end to the bottom end; and an inner surface defining a sample cavity, wherein the top end defines an opening for the sample cavity, wherein a plurality of recessed portions are defined in the outer surface proximate to the bottom end of the sampling tube.
Illustration 2. The sampling tube of any preceding or subsequent illustration or combination of illustrations, wherein each recessed portion of the plurality of recessed portions comprises a recessed portion surface, and wherein at least a portion of the recessed portion surface defines a pocket is between the inner surface and the outer surface.
Illustration 3. The sampling tube of any preceding or subsequent illustration or combination of illustrations, wherein the plurality of recessed portions comprises at least four recessed portions.
Illustration 4. The sampling tube of any preceding or subsequent illustration or combination of illustrations, wherein the outers surface comprises a bottom portion comprising the bottom end, the bottom portion comprising a rounded profile.
Illustration 5. The sampling tube of any preceding or subsequent illustration or combination of illustrations, wherein the sample cavity comprises a cylindrical portion and a conical portion, wherein the conical portion of the sample cavity is proximate to the bottom end of the sampling tube.
Illustration 6. The sampling tube of any preceding or subsequent illustration or combination of illustrations, wherein each recessed portion of the plurality of recessed portions comprises a scalloped opening.
Illustration 7. The sampling tube of any preceding or subsequent illustration or combination of illustrations, wherein a length of each recessed portion is less than a distance from the top end to the bottom end.
Illustration 8. A sampling tube comprising: a top end; a bottom end; an outer surface extending from the top end to the bottom end; and an inner surface defining a sample cavity, wherein the top end defines an opening for the sample cavity, wherein the sample cavity comprises a tubular section and a changing diameter section, wherein the changing diameter section is proximate to the bottom end, wherein the changing diameter section comprises a plurality of sub-sections, and wherein a first sub-section of the plurality of sub-sections comprises a decreasing diameter and a second sub-section of the plurality of sub-sections comprises a constant diameter.
Illustration 9. The sampling tube of any preceding or subsequent illustration or combination of illustrations, further comprising a third sub-section with a decreasing diameter, and wherein the third sub-section defines a bottom end of the sample cavity.
Illustration 10. The sampling tube of any preceding or subsequent illustration or combination of illustrations, wherein the second sub-section is between the first sub-section and the third sub-section.
Illustration 11. The sampling tube of any preceding or subsequent illustration or combination of illustrations, wherein: a maximum diameter of the first sub-section is the same as a diameter of the tubular section; a minimum diameter of the first sub-section is the same as the constant diameter of the second sub-section; and a maximum diameter of the third sub-section is the same as the constant diameter of the second sub-section.
Illustration 12. The sampling tube of any preceding or subsequent illustration or combination of illustrations, wherein a maximum diameter of the first sub-section is greater than the constant diameter of the second sub-section.
Illustration 13. The sampling tube of any preceding or subsequent illustration or combination of illustrations, wherein the first sub-section is adjacent the tubular section.
Illustration 14. A sampling tube comprising: a top end; a bottom end; an outer surface extending from the top end to the bottom end, wherein the outer surface comprises a tubular portion and a rounded portion, the rounded portion including the bottom end; and an inner surface defining a sample cavity, wherein the top end defines an opening for the sample cavity, and wherein the sample cavity comprises a tubular portion and a conical portion, the conical portion proximate to the bottom end.
Illustration 15. The sampling tube of any preceding or subsequent illustration or combination of illustrations, wherein the tubular portion of the outer surface and the tubular portion of the sample cavity include the top end.
Illustration 16. The sampling tube of any preceding or subsequent illustration or combination of illustrations, wherein the conical portion comprises a plurality of sub-sections, the plurality of sub-sections comprising at least one sub-section with a decreasing diameter and at least one sub-section with a constant diameter.
Illustration 17. The sampling tube of any preceding or subsequent illustration or combination of illustrations, wherein a plurality of recessed portions are defined in the outer surface proximate to the bottom end of the sampling tube.
Illustration 18. The sampling tube of any preceding or subsequent illustration or combination of illustrations, wherein each recessed portion of the plurality of recessed portions comprises a recessed portion surface, and wherein at least a portion of the recessed portion surface is between the inner surface and the outer surface.
Illustration 19. The sampling tube of any preceding or subsequent illustration or combination of illustrations, wherein a length of each recessed portion of the plurality of recessed portions is less than a length of the sample cavity.
Illustration 20. The sampling tube of any preceding or subsequent illustration or combination of illustrations, wherein the plurality of recessed portions comprises at least four recessed portions.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A sampling tube comprising:
a top end;
a bottom end;
an outer surface extending from the top end to the bottom end; and
an inner surface defining a sample cavity, wherein the top end defines an opening for the sample cavity,
wherein a plurality of recessed portions are defined in the outer surface proximate to the bottom end of the sampling tube.

2. The sampling tube of claim 1, wherein each recessed portion of the plurality of recessed portions comprises a recessed portion surface, and wherein at least a portion of the recessed portion surface defines a pocket is between the inner surface and the outer surface.

3. The sampling tube of claim 1, wherein the plurality of recessed portions comprises at least four recessed portions.

4. The sampling tube of claim 1, wherein the outers surface comprises a bottom portion comprising the bottom end, the bottom portion comprising a rounded profile.

5. The sampling tube of claim 1, wherein the sample cavity comprises a cylindrical portion and a conical portion, wherein the conical portion of the sample cavity is proximate to the bottom end of the sampling tube.

6. The sampling tube of claim 1, wherein each recessed portion of the plurality of recessed portions comprises a scalloped opening.

7. The sampling tube of claim 1, wherein a length of each recessed portion is less than a distance from the top end to the bottom end.

8. A sampling tube comprising:
a top end;
a bottom end;
an outer surface extending from the top end to the bottom end; and
an inner surface defining a sample cavity, wherein the top end defines an opening for the sample cavity,
wherein the sample cavity comprises a tubular section and a changing diameter section,
wherein the changing diameter section is proximate to the bottom end,
wherein the changing diameter section comprises a plurality of sub-sections, and
wherein a first sub-section of the plurality of sub-sections comprises a decreasing diameter and a second sub-section of the plurality of sub-sections comprises a constant diameter.

9. The sampling tube of claim 8, further comprising a third sub-section with a decreasing diameter, and wherein the third sub-section defines a bottom end of the sample cavity.

10. The sampling tube of claim 9, wherein the second sub-section is between the first sub-section and the third sub-section.

11. The sampling tube of claim 9, wherein:
a maximum diameter of the first sub-section is the same as a diameter of the tubular section;
a minimum diameter of the first sub-section is the same as the constant diameter of the second sub-section; and
a maximum diameter of the third sub-section is the same as the constant diameter of the second sub-section.

12. The sampling tube of claim 8, wherein a maximum diameter of the first sub-section is greater than the constant diameter of the second sub-section.

13. The sampling tube of claim 8, wherein the first sub-section is adjacent the tubular section.

14. A sampling tube comprising:
a top end;
a bottom end;
an outer surface extending from the top end to the bottom end, wherein the outer surface comprises a tubular portion and a rounded portion, the rounded portion including the bottom end; and
an inner surface defining a sample cavity, wherein the top end defines an opening for the sample cavity, and wherein the sample cavity comprises a tubular portion and a conical portion, the conical portion proximate to the bottom end.

15. The sampling tube of claim 14, wherein the tubular portion of the outer surface and the tubular portion of the sample cavity include the top end.

16. The sampling tube of claim 14, wherein the conical portion comprises a plurality of sub-sections, the plurality of sub-sections comprising at least one sub-section with a decreasing diameter and at least one sub-section with a constant diameter.

17. The sampling tube of claim 14, wherein a plurality of recessed portions are defined in the outer surface proximate to the bottom end of the sampling tube.

18. The sampling tube of claim 17, wherein each recessed portion of the plurality of recessed portions comprises a recessed portion surface, and wherein at least a portion of the recessed portion surface is between the inner surface and the outer surface.

19. The sampling tube of claim 17, wherein a length of each recessed portion of the plurality of recessed portions is less than a length of the sample cavity.

20. The sampling tube of claim 17, wherein the plurality of recessed portions comprises at least four recessed portions.
